(19) United States
(12) Patent Application Publication
(10) Pub. No.: US 2023/0035878 A1
(43) Pub. Date: Feb. 2, 2023

(54) METHOD AND PLANT FOR AERAULIC SEPARATION

(71) Applicant: Bigarren Bizi, Bidart (FR)

(72) Inventor: Stèphane Peys, Bidart (FR)

(21) Appl. No.: 17/277,109

(22) PCT Filed: Sep. 17, 2019
(86) PCT No.: PCT/IB2019/057821

§ 371 Date: Sep. 1, 2021

(30) Foreign Application Priority Data
Sep. 17, 2018 (FR) 18/58373

(51) Int. Cl. B03B 9/06; B07B 9/02

(52) U.S. Cl. CPC B03B 9/06; B07B 9/02; B07B 7/083

(57) ABSTRACT

A method _{ES1} for the continuous aeraulic separation of particulate materials stemming from electronic scrap and made up of a mixture of particles which are heterogeneous in terms of both particle size and density, characterized in that it comprises the following successive steps:
(a) grinding the particles
(b) generating a gas flow carrying the ground particles,
(c) carrying out a first aeraulic separation over said gas flow in order to separate the particles contained therein into a first fraction made up of the coarsest particles of various densities, and a second fraction made up of the finest particles,
(d) carrying out a second aeraulic separation of said first fraction in order to separate the particles contained therein into a third fraction made up of the coarsest and densest particles and a fourth fraction made up of the coarsest and least dense particles,
(e) reinjecting the third or the fourth fraction to the grinding input, and
(f) recovering the second and the fourth fraction or the third fraction, as applicable, as output products.

### FIELD OF THE INVENTION

The present invention relates in a general way to the aeraulic grinding and separation processing of particulate materials, and more particularly the separation processing of particulate materials that are heterogeneous in terms of size, density and shape.

It applies to the processing of electronic scrap, but may also be applied to various fields, in particular to the processing of minerals, waste from construction and public works, plant material in particular biomass, food products, etc.

### PRIOR ART

With reference to FIG. 1 of the drawings, the separation processing of heterogeneous particulate materials M in order to separate different types of ingredients from one another generally comprises a step B of grinding until a given particle-size range is achieved, a first classification CL1 by size intended to separate the particles into the coarsest particles and the finest particles, a second classification CL2 intended to separate the finest particles into particles having different properties (typically a densimetric classification to separate the densest from least dense particles). In some applications, the denser particles are metals which are to be recovered from the scrap.

In this type of known approach, the coarsest particles stemming from the first separation step are reinjected at the input of the grinder to be sub-divided again.

### SUMMARY OF THE INVENTION

The present invention aims to improve the existing methods of separating heterogeneous materials and to allow, through a novel combination of grinding and aeraulic classification, a fraction to be produced containing particles that are classified in terms of both particle size and density and another fraction that is also classified in terms of particle size and density (for example, a fraction with finer and denser particles and a second fraction with coarser and less dense particles).

Thus, according to a first aspect, a method is proposed for the continuous aeraulic separation of particulate materials stemming from electronic scrap and made up of a mixture of particles which are heterogeneous in terms of both particle size and density, characterized in that it comprises the following successive steps:

(a) grinding the particles

(b) generating a gas flow carrying the ground particles,

(c) carrying out a first aeraulic separation over said gas flow in order to separate the particles contained therein into a first fraction made up of the coarsest particles of various densities, and a second fraction made up of the finest particles,

(d) carrying out a second aeraulic separation of said first fraction in order to separate the particles contained therein into a third fraction made up of the coarsest and densest particles and a fourth fraction made up of the coarsest and least dense particles,

(e) reinjecting the third or the fourth fraction to the grinding input, and

(f) recovering the second and the fourth fraction or the third fraction, as applicable, as output products.

Advantageously but optionally, said method comprises the following additional characteristics, taken individually or in any technically compatible combinations:
the first aeraulic separation unit comprises a dynamic classifier associated with a particle recuperator.
the second fraction is recovered from the gas flow and is conveyed mechanically to a gas flow supplying the second aeraulic separation unit.
the second aeraulic separation unit comprises a dynamic classifier associated with a particle recuperator.
the third or the fourth fraction is recovered from the gas flow and is conveyed mechanically to the input of the grinding step.
the method is applied to the separation of particulate materials containing metals and lighter non-metals, and the step (e) comprises the reinjection of the third fraction to the grinding input, to thus recover a second fraction comprising particles with the finest particle size having a higher proportion of metals relative to the initial particles, and a fourth fraction comprising particles with the coarsest particle size having a higher proportion of non-metals relative to the initial particles.

According to a second aspect, a plant is proposed for the continuous aeraulic separation of particulate materials stemming from electronic scrap and made up of a mixture of heterogeneous particles in terms of both particle size and density, characterized in that it comprises in combination:
a grinder supplied with a material for processing,
a means for producing at the output of the grinder a gaseous flow containing the particles stemming from the grinding,
a first aeraulic classifier receiving said gaseous flow and suitable for producing a first fraction containing the particles containing the coarsest particles and a second fraction containing the finest particles,
a second aeraulic classifier receiving said second fraction and suitable for producing a third fraction containing the coarsest and least dense particles and a fourth fraction containing the coarsest and most dense particles, and
means for conveying the third fraction or the fourth fraction to the input of the grinder.

Said plant advantageously but optionally comprises the following additional characteristics, taken individually or in any technically compatible combinations:
the first aeraulic classifier comprises a dynamic classifier associated with a particle recuperator.
the plant further comprises a pipe for reinjecting the flow of clean air coming out of the recuperator to the input of the grinder.
the plant further comprises mechanical means for conveying the particles of the first fraction to a diffuser interposed on an input pipe of the second classifier.
the second aeraulic classifier comprises a second dynamic classifier associated with a second particle recuperator.
the plant further comprises a pipe for reinjecting the flow of clean air coming out of the second recuperator to the input of the second dynamic classifier.
the plant further comprises mechanical means for conveying the particles from the third or fourth fraction to the input of the grinder.

### BRIEF DESCRIPTION OF THE DRAWINGS

The invention will be better understood on reading the description that follows of preferred embodiments thereof, given as non-limiting examples and with reference to the accompanying drawings, in which:

FIG. 1, already described in the introduction, is a general plan of a method of separating heterogeneous particulate matter according to the prior art,

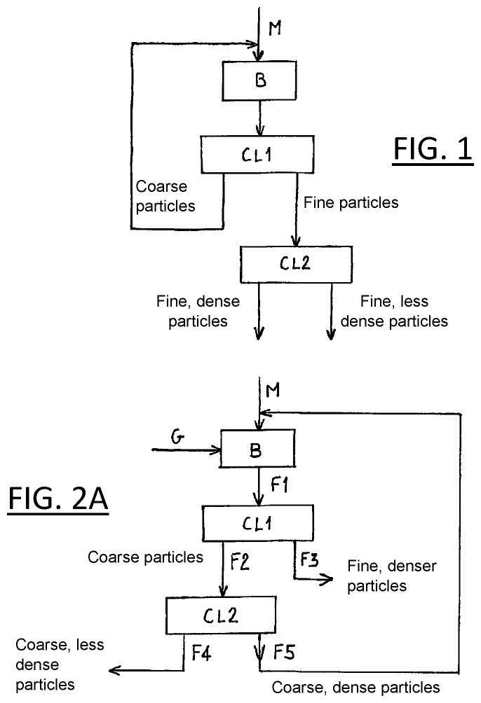

FIGS. 2A and 2B are two general plans of two methods of separating heterogeneous particulate matter according to two variants of the present invention, and

FIG. 3 shows an example of a plant for implementing the method of FIG. 2A.

### DETAILED DESCRIPTION OF PREFERRED EMBODIMENTS

It will be noted in the introduction that terms “coarse”, “fine”, “dense”, “not very dense”, etc., alone or associated with comparative or relative terms, should be viewed through the eyes of a person skilled in the art, in other words as characteristic, median or average values of a given particulate composition, covering ranges that in reality may overlap.

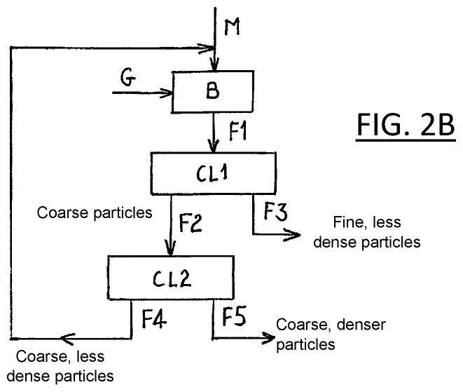

With reference first to FIGS. 2A and 2B, a method of separating particulate materials according to the invention will be described.

Common to both figures, the initial material M, which may be pre-fractioned by means that are known per se, is introduced into a grinder B which also receives a flow of gas G (typically air) so as to generate an aeraulic flow F1 containing particles in a relatively wide range of particle sizes, having a maximum size, for example, of less than 500 μm.

Said flow F1 is applied to the input of a first classification unit CL1 intended to separate the particles into a flow F2 of the coarsest particles and a flow F3 of the finest particles.

Unlike the method of the prior art where the flow F2 of coarse particles is redirected directly to the input of the grinder, said flow in this case is subjected to densimetric classification at a second classifier CL2 which generates a flow F4 of the least dense coarse particles and a flow F5 of the most dense coarse particles.

At this point, the method may be subject to two implementation variants, depending on the nature of the product to be processed and the application proposed.

Thus, in a first implementation shown in FIG. 2A, the densest coarse particles (flow F5) are redirected to the input of the grinder B, while the flow F4 of the least dense coarse particles is recovered as a finished or intermediate product.

In a second implementation shown in FIG. 2B, the least dense coarse particles (flow F4) are redirected to the input of the grinder B, while the flow F5 of the densest coarse particles is recovered as a finished or intermediate product.

At the same time, the flow F3 of the finest particles is recovered to form another finished or intermediate product.

The implementation in FIG. 2A is applicable in particular to recovering metallic products in an initial material made up of waste (electronic scrap, waste from manufacturing industry in general, from the construction and public works sector, etc.). Thus, by supplying the grinder continuously with the initial material, and quickly removing the lightest particles (in this case the non-metals: polymers, various minerals, etc.) from the processed flows while still in the coarse state, a particularly efficient method is achieved for obtaining particles at the flow F3 that are both fine and have a substantially higher concentration of metals (denser) than the initial material.

Said flow F3 thus constitutes directly the finished or intermediate product primarily sought.

The flow F4, formed, depending on the circumstances, of minerals, polymers, etc., also forms a finished or intermediate product of the processing, which can be reused appropriately depending on the nature thereof and the proposed application, and may for example supply the recycling industry.

The implementation in FIG. 2B is applicable in particular where the most sought-after fraction of the initial product is the least dense fraction (for example in the case of nut shells recovered as fuel). In this case, the rapid extraction of the coarsest and densest fraction F5 allows particularly effective recovery from the flow F3 of an intermediate or finished product having a fine particle size and low density (in this case, nut shells which may for example be pelletized to form a fuel).

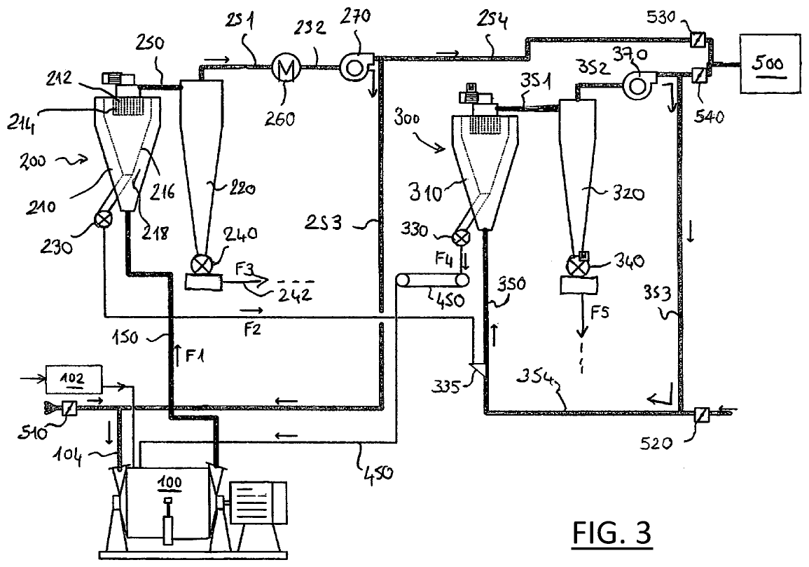

With reference to FIG. 3, a plant will now be described intended for recovering from electronic scrap containing on the one hand metals and on the other hand non-metals that are less dense than the metals, firstly a basically metallic fraction with a fine particle size, and secondly a basically non-metallic fraction with a coarser particle size.

Said plant comprises first a grinder 100 (grinder B in FIG. 2A) receiving at the input (for example via a pneumatic conveyor, not shown) particulate materials 102, for example pre-ground electronic scrap in an initial state not shown, in a particle size for example of between 0 mm and 10 mm.

The grinder also receives via a pipe 104 a flow of clean or slightly dust-laden gas (usually air) intended to carry the particles output by the grinder 100.

Said grinder may be produced according to any known technology (compression, impact or attrition, depending on the nature and size of the input material to be ground) and designed to reduce the initial fragments to a powder having a particle size typically of less than about 500 μm. In general, said maximum particle size is chosen to ensure effective physical separation between the metallic particles and the non-metallic particles in the particulate material, preventing as far as possible the presence of grains containing both metallic and non-metallic materials.

The particles output by the grinder are transported by the gas flow passing through the grinder, into a pipe 150 (flow F1) to a first aeraulic separation station 200, said station comprising in this case a dynamic turbine classifier 210 of a type known per se associated with one or more recuperators 220 of the particles contained in the air, for example using a cyclone, sack filter or pocket filter recuperators, all known per se.

The classifier 210 comprises schematically a rotor 212 comprising blades 214 rotating at a suitable speed above a collecting hopper 216.

The airflow F1 carrying the particles is transported via the base of the device through a peripheral tapered ring-shaped space 218 positioned between the outer wall of the separator and the hopper 216. In the region of the blades 214 of the rotor, the particles are subjected to the combined effect of centrifugation, aeraulic driving and gravitational falling, such that ultimately the finest particles pass through the rotor and come out in the airflow in an upper outlet pipe 250 of the separator, and the coarsest particles are kept outside the rotor and accumulate at the bottom of the hopper, where said particles are removed for example by a rotary airlock 230.

Said separator, with a powder containing metals and non-metals, allows a first recovery to be made in the airflow coming out in the upper portion, of fines having a substantially higher proportion of metallic particles than in the initial grindings with, as a corollary, a lower proportion of non-metallic particles, while the coarser particles, containing a higher proportion of non-metals relative to the initial grindings, are recovered at the bottom of the separator 210 and removed via the rotary airlock 230 to undergo a second classification as will be seen below (flow F2).

The pipe 250 is connected to the input of the particle recuperator 220, for example one or more cyclones, sack filters or pocket filters, the parameters of which are adjusted so as to eliminate from the airflow most of the fines in suspension therein. As already mentioned, said particles are fine particles with a higher proportion of metals, and form a first product of the processing. Said particles are recovered by a rotary airlock 240 to form a finished product or alternatively to be sent (arrow 242) for further processing (flow F3).

If the above plant is used for recycling electronic scrap, said particles may comprise different metals, including precious metals, and may be redirected to a station to be placed in liquid suspension, then downstream to one or more units for separating the metals from each other, preferably using a density measuring approach with, if applicable, prior magnetic separation, for example as described in document WO2016042469A1.

The airflow leaving the particle recuperator 220 circulates in a pipe 251 to a heat exchanger 260 then to an extractor fan 270, which produces the airflow in the grinder and in the separation station 200. Said airflow, which may still be slightly charged with particles, is reinjected to the input of the grinder 100 via a pipe 253. It should be noted here that the heat exchanger 260 allows the air to be cooled before being returned to the input of the grinder, particularly if the basic operating principle of said grinder results in a significant rise in the temperature of the airflow and of the particles transported.

The dynamic turbine classifier 210 is advantageously of the type having an adjustable separation threshold, and chosen for example to allow a particle size of up to 5 mm to enter, with a separation threshold adjustable between 3 μm and 400 μm.

Said first separation station 200 is connected operationally to a second separation station 300 also formed in this case of a dynamic turbine classifier 310 of a type known per se, combined with one or more other particle recuperators 320, preferably of the same type as the recuperator(s) 220.

More specifically, the fraction F2 coming from the rotary airlock 230 associated with the classifier 210, made up of the coarsest particles, both metallic and non-metallic, is transported by a gravitational or mechanical conveyor (line 231) and injected via a diffusor 335 into an airflow carried in a pipe 350, which supplies the base of the classifier 310. Said classifier 310 advantageously has the same structure as that of the classifier 210, which structure will not be described again, it being recalled that such classifiers are known per se. Said classifier is parameterized in such a way that the coarsest and densest particles are kept outside the turbine and accumulate at the bottom of the hopper. Said particles are collected by a rotary airlock 330 and reinjected via a gravitational or mechanical conveying line 450 to the input of the grinder 100 (flow F4).

The least dense particles return into the airflow in the upper portion of the classifier 310. Said flow is transported via a pipe 351 to a particle recuperator 320 which removes the particles therefrom, forming in this case a second product from the processing obtained by the plant, namely a relatively coarse powder with a higher proportion of non-metals. Said particles accumulate in the lower portion and are removed via a rotary airlock 340 to be transported and for example packaged for recycling (flow F5).

The upper portion of the recuperator 320 is connected by a pipe 352 to an extractor fan 370 which generates the airflow through the station 300, and the outlet of said fan is connected via pipes 353, 354 to the above-mentioned diffuser 335.

Registers 510, 520, 530, 540 may be controlled in order, as applicable:
to allow fresh air to be taken to the grinder via the pipe 104,
to allow air to be taken to the mixer 335 via the pipe 354,
to allow excess air from the fan 270 to be discharged to the atmosphere, via a filtration station 500 eliminating the last particles (of a type known per se).
to allow in the same way the airflow from the fan 370 to be discharged to the atmosphere via the filtration station 500.

Thus, the plant in FIG. 3, by a particular combination of grinding and a dual classification stage, without recourse to different steps for particle size classification and densimetric classification, allows on the one hand a fraction (F3) containing the finest particles with a substantially higher proportion of metals and on the other hand a fraction (F4) containing the coarsest particles with a substantially higher proportion of non-metals, to be obtained in a particularly effective and economical way.

The plant as described with reference to FIG. 3 can easily be modified by a person skilled in the art in order to implement the variant of the method shown in FIG. 2B, by changing the allocation of the flows output in the region of the device 300 forming the second classifier.

Naturally, the present invention is in no way limited to the preceding description, and a person skilled in the art will be able to apply numerous variants or modifications thereto.

1. Method for the continuous aeraulic separation of particulate materials stemming from electronic scrap and made up of a mixture of particles which are heterogeneous in terms of both particle size and density, characterized in that it comprises the following successive steps:
(a) grinding the particles
(b) generating a gas flow carrying the ground particles,
(c) carrying out a first aeraulic separation over said gas flow in order to separate the particles contained therein into a first fraction made up of the coarsest particles of various densities, and a second fraction made up of the finest particles,
(d) carrying out a second aeraulic separation of said first fraction in order to separate the particles contained therein into a third fraction made up of the coarsest and densest particles and a fourth fraction made up of the coarsest and least dense particles,
(e) reinjecting the third or the fourth fraction to the grinding input, and
(f) recovering the second and the fourth fraction or the third fraction, as applicable, as output products.

2. Method according to claim 1, wherein the first aeraulic separation unit comprises a dynamic classifier associated with a particle recuperator.

3. Method according to claim 1, wherein the second fraction is recovered from the gas flow and is conveyed mechanically to a gas flow supplying the second aeraulic separation unit.

4. Method according to claim 1, wherein the second aeraulic separation unit comprises a dynamic classifier associated with a particle recuperator.

5. Method according to claim 1, wherein the third or the fourth fraction is recovered from the gas flow and is conveyed mechanically to the input of the grinding step.

6. Method according to claim 1, applied to the separation of particulate materials containing metals and lighter non-metals, in which the step (e) comprises the reinjection of the third fraction to the grinding input, to thus recover a second fraction comprising particles with the finest particle size having a higher proportion of metals relative to the initial particles, and a fourth fraction comprising particles with the coarsest particle size having a higher proportion of non-metals relative to the initial particles.

7. Plant for the continuous aeraulic separation of particulate materials stemming from electronic scrap and made up of a mixture of heterogeneous particles in terms of both particle size and density, characterized in that it comprises in combination:
a grinder (100) supplied with a material for processing,
a means (510, 104) for producing at the output of the grinder a gaseous flow (F1) containing the particles stemming from the grinding,
a first aeraulic classifier (200) receiving said gaseous flow and suitable for producing a first fraction (F2) containing the particles containing the coarsest particles and a second fraction (F3) containing the finest particles,
a second aeraulic classifier (300) receiving said second fraction and suitable for producing a third fraction (F4) containing the coarsest and least dense particles and a fourth fraction (F5) containing the coarsest and most dense particles, and
means (450) for conveying the third fraction (F4) or the fourth fraction (F5) to the input of the grinder.

8. Plant according to claim 7, wherein the first aeraulic classifier (200) comprises a dynamic classifier (210) associated with a particle recuperator (220).

9. Plant according to claim 8, which further comprises a pipe (253) for reinjecting the flow of clean air coming out of the recuperator (220) to the input of the grinder (100).

10. Plant according to claim 8, which further comprises mechanical means for conveying the particles of the first fraction (F2) to a diffuser (335) interposed on an input pipe (350) of the second classifier.

11. Plant according to claim 7, wherein the second aeraulic classifier (300) comprises a second dynamic classifier (310) associated with a second particle recuperator (320).

12. Plant according to claim 11, which further comprises a pipe (353) for reinjecting the flow of clean air coming out of the second recuperator (320) to the input of the second dynamic classifier (310).

13. Plant according to claim 11, which further comprises mechanical means for conveying the particles from the third or fourth fraction to the input of the grinder (100).
